(19) United States
(12) Patent Application Publication
(10) Pub. No.: US 2017/0131856 A1
(43) Pub. Date: May 11, 2017

(54) System and Method for a Hybrid User Interface for the Display of Analytical Data Related to Real-time Search Engine Optimization Issue Detection and Correction

(71) Applicants: Hamlet Francisco Batista Reyes, Old Bridge, NJ (US); Anup Shinde, Ahmedabad (IN)

(72) Inventors: Hamlet Francisco Batista Reyes, Old Bridge, NJ (US); Anup Shinde, Ahmedabad (IN)

(21) Appl. No.: 15/231,737

(22) Filed: Aug. 8, 2016

Related U.S. Application Data
(63) Continuation of application No. 62/201,635, filed on Aug. 6, 2015.

(51) Int. Cl. G06F 3/0482; G06F 9/44; G06F 21/31; G06F 3/0485; G06F 17/30; G06F 21/62; H04L 29/08; G06F 3/0484

(52) U.S. Cl. CPC G06F 3/0482; H04L 67/20; G06F 9/4443; G06F 3/04847; G06F 3/0485; G06F 17/30864; G06F 17/30896; G06F 21/629; G06F 21/31; H04L 67/02

(57) ABSTRACT

A portion of a dashboard that is directly embedded into a third party website analytics dashboard, (for example, Google Analytics)), by means of content injection using a web browser extension. This provides a seamless experience to the user. The system and method relies on the following parts for the dashboard to work: User's third party analytics account, i.e. Analytics account; Web browser extension; and one or more additional dashboard pages and data service. The website must be configured first at the Dashboard server before it can be utilized. This is typically performed by the Dashboard Server Administrator. Once configured, the website has its dashboard related data in its container. The Dashboard Administrator must also assign at least one Administrator user for that website. This Administrator account is same as the Analytics Administrator account.

### CROSS REFERENCE TO RELATED APPLICATIONS

This application is related to and claim priority from U.S. Provisional Patent Application Ser. No. 62/201,635, entitled “System and Method for a Hybrid User Interface for the Display of Analytical Data Related to Real-time Search Engine Optimization Issue Detection and Correction”, filed on 6 Aug. 2015.

This application is related to U.S. Provisional Patent Application Ser. No. 62/046,302, entitled “System and Method for Real-time Search Engine Optimization Issue Detection and Correction”, filed on 5 Sep. 2014.

### FEDERALLY SPONSORED RESEARCH

Not Applicable

### SEQUENCE LISTING OR PROGRAM

Not Applicable

### TECHNICAL FIELD OF THE INVENTION

The present invention relates generally to web browser displays and extensions. More specifically, the present invention relates to a new method for displaying complementary analytics on a third party dashboard display using a web browser extension.

### BACKGROUND OF THE INVENTION

Designing the visual composition and temporal behavior of a GUI is an important part of software application programming in the area of human-computer interaction. Its goal is to enhance the efficiency and ease of use for the underlying logical design of a stored program, a design discipline known as usability. Methods of user-centered design are used to ensure that the visual language introduced in the design is well tailored to the tasks.

The visible graphical interface features of an application are sometimes referred to as a “GUI” (Goo-ee). Typically, the user interacts with information by manipulating visual widgets that allow for interactions appropriate to the kind of data they hold. The widgets of a well-designed interface are selected to support the actions necessary to achieve the goals of the user.

Most of the competitive existing solutions in the market require the user to login to their proprietary dashboard to see their analytics. That requires extra steps and creates friction in the user experience. Ultimately that results into lesser usage of the software and less perceived utility.

Additionally, custom user interfaces require some amount of training and have a learning curve associated before these can be utilized.

### DEFINITIONS

In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising the interface. A good API makes it easier to develop a program by providing all the building blocks. A programmer then puts the blocks together.

In addition to accessing databases or computer hardware, such as hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications.

APIs often come in the form of a library that includes specifications for routines, data structures, object classes, and variables. In other cases, notably SOAP and REST services, an API is simply a specification of remote calls exposed to the API consumers.

An API specification can take many forms, including an International Standard, such as POSIX, vendor documentation, such as the Microsoft Windows API, or the libraries of a programming language, e.g., the Standard Template Library in C++ or the Java APIs.

CHROME or GOOGLE CHROME is a freeware web browser developed by GOOGLE. It used the WEBKIT layout engine until version 27 and, with the exception of its iOS releases, from version 28 and beyond uses the WEBKIT fork BLINK.

A software extension is software that serves to extend the capabilities of or data available to an existing software application; it becomes included in the program. This term often (mistakenly) coincides with the plug-in. When installing software, one may be instructed to take one or more steps related to installing extensions (or these steps may automatically be done for the user).

“Add-on” is often considered the general term comprising snap-ins, plug-ins, extensions, and themes.

Frames allow a visual HTML Browser window to be split into segments, each of which can show a different document. This can lower bandwidth use, as repeating parts of a layout can be used in one frame, while variable content is displayed in another. This may come at a certain usability cost, especially in non-visual user agents, due to separate and independent documents (or websites) being displayed adjacent to each other and being allowed to interact with the same parent window. Because of this cost, frames (excluding the <iframe> element) are only allowed in HTML 4.01 Frame-set. Iframes can also hold documents on different servers. In this case the interaction between windows is blocked by the browser. Sites like Facebook and twitter use Iframes to display content (plugins) on third party websites. Google Adsense uses Iframes to display banners on third party websites.

A web browser (commonly referred to as a browser) is a software application for retrieving, presenting and traversing information resources on the World Wide Web. An information resource is identified by a Uniform Resource Identifier (URI/URL) and may be a web page, image, video or other piece of content. Hyperlinks present in resources enable users easily to navigate their browsers to related resources.

Although browsers are primarily intended to use the World Wide Web, they can also be used to access information provided by web servers in private networks or files in file systems.

Physical Page: Html source of specific URL as found in database in a content management system (like Wordpress), or in a text HTML file in the file system Virtual HTML Stream In-memory Html source of specific URL as read and found inside a web server during client request processing.

Permanent Physical Headers: Response headers of specific URL as defined in the web server configuration

Virtual Headers: In-memory response headers of specific URL as set by server and found inside a web server during client request processing

Permanent Physical Fixes: These are html or header changes that are permanent in the html source (flat files or CMS/database)

Temporary Virtual Fixes: There are html or header changes that are applied in real-time to the in-memory html content and/or headers.

Server Module: Lightweight web server module/filter that monitors pages for changes notifies daemon service and applies temporary virtual fixes found in a lookup database. The Server Module has two main tasks: 1. Applying real-time fixes found in the Temporary Fixes Map 2; and Notifying Daemon Service of page changes for further analysis.

Daemon Service: Heavy duty server process that listens for URL change notifications, compares changes to correct SEO state databases, updates the temporary fixes database(s), and sends reports to real-time dashboard. Daemon Service has three main tasks: 1. Analyzing HTML received from Server Module for potential SEO issues; 2. Adding or removing entries from the Temporary Fixes Map; and 3. Notifying the real-time dashboard when problems are detected, and temporarily or permanently fixed.

Temporary Fixes Maps: DBM file(s) with fixes/changes to perform in real-time to URLs based in lookup. For example, the present invention will have a map with URLs that need the canonical tag replaced. We will have another map for URLs that need the no index tag added/removed. We will have maps for main SEO issue as outlined above. These maps will consist of static URL mappings.

Correct SEO State Maps: DBM file(s) with the correct SEO state of all pages of the site. Similar to the Temporary Fixes Maps, the present invention has maps for each SEO issue: canonicals, redirects, robots tags, etc.

In order to generalize the solution, the present invention uses page types, in addition to static URL maps. For example, instead of individual canonical mappings for all product URLs, the present invention has one or more rules to apply to all product URLs as a group.

The maps have page detection rules as regex, or xpath instructions; and corresponding transformation rules as regex replacements or xslt rules.

Some elements, like the robots tag, have default values if not present. They should be handled as if they had the default values instead of adding to these maps.

Unknown SEO State Maps: DBM file(s) with the URLs for which their correct SEO state is unknown because they are not matched by any of the rules in the Correct SEO State Maps (and don't have default values).

The purpose of these maps is to periodically review them manually, and add new rules to the Correct SEO State Maps. Similar to the Temporary Fixes Maps, the present invention has maps for each SEO issue: canonicals, redirects, robots tags, etc. These maps will contain static URL mappings.

### SUMMARY OF THE INVENTION

The present invention teaches a portion of a dashboard that is directly embedded into a third party website analytics dashboard, (for example Google Analytics), by means of content injection using a web browser extension, (for example a Google Chrome extension). This provides a seamless experience to the user. Third party website analytics dashboards like GOOGLE Analytics are used by millions of website owners, the dashboard feels familiar as many users are trained on it. This makes it very easy for users to get started with the dashboard taught by the present invention.

The system and method relies on the following parts for the dashboard to work: 1. User's third party analytics account, i.e. GOOGLE Analytics account; 2. Web browser extension, i.e. CHROME Extension; and 3. additional dashboard pages and data service.

The website must be configured first at the Dashboard server before it can be utilized. This is typically performed by the Dashboard Server Administrator. Once configured, the website has its dashboard related data in its container (called namespaces). The Dashboard Administrator must also assign at least one Administrator user for that website. This Administrator account is same as the third party analytics administrator account, i.e.: GOOGLE Analytics Administrator account.

After creating the website's container and assigning administrative rights to one account, the website is not considered as “configured” for the Dashboard(s) taught by the present invention.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 illustrates the Asynchronous Processes With Change Detection;

FIGS. 2-4 illustrate the real-time dashboard taught by the present invention.

FIG. 5 illustrates the real-time dashboard taught by the present invention where notifications are integrated on top of the analytical notifications.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The system of the present invention is doing something commonly done by a combination of SEO experts and website developers. The SEO experts provide insight into what needs to be done, and the developers execute. In this sense, the SEO experts audit the sites to see if it is coded with best practices in mind, and the developers fix any issues found.

What the system of the present invention does is move to an ideal state where the site is getting audited and fixed constantly and automatically.

The present invention improves drastically over a previous design in four areas with respect to: 1. Speed of detection and correction of issues 2. Transparency of the problems detected and fixed 3. Control of what gets fixed and what doesn't (oversight) 4. Realtime technical SEO analytics without crawling the sites.

These improvements address specific client concerns and needs. As the system is doing changes in real-time, clients get concerned about possible slow downs that can affect users. Visibility into what the system is doing is also critical to give confidence that the system is not making costly mistakes. Some clients with in-house teams of experts would want to have some control over what the system is doing. In addition, the present invention saves clients from having to run specialized SEO crawlers to find issues, as the issues are detected passively as search engines crawl the site.

All competing solutions audit sites by running external website crawls. Such a program, which would simulate a search engine and visit all pages and links to find issues. The new product of the present invention, audits the site without requiring a crawl, because it passively waits for search engines to visit each page of the site. Let's call this “a passive crawl”. As the search engines visit the site, the audit of each page is triggered.

There are three modes of operation help balance between speed, and results. Async mode is the fastest, but the search engine won't see the fix immediately. Sync is the slowest and useful during debugging and testing. Quicksync provides the best compromise of speed and immediate results.

Now referring to the Figures, the embodiment of the present invention is shown. The present invention focuses on detecting and fixing any technical SEO issues. Here are some specific examples: Missing and incorrect canonical tags; Missing and incorrect meta robots tags; Missing and incorrect pagination tags; Chained redirects; Missing canonical redirects; Missing and incorrect Vary header; Missing and incorrect hreflang tags; Missing, short or duplicate titles; Missing, short or duplicate meta descriptions; Missing and incorrect mobile alternate tags; 404 errors due to URL moves; Search engine unfriendly URLs; Infinite crawl spaces (bot traps); and Missing image alt tags.

Web server module(s) does minimal processing, like detecting page changes, and updating specific html for a specific set of pages. The Daemon service does all the heavy lifting: extracting the SEO state of the pages identified as changed, comparing the SEO state with the correct state stored in the maps, updating the temporary fixes database with the correct changes/fixes, and notifying the real-time dashboard of the problems and fixes.

The SM communicates with the DS using a simple HTTP POST request with the URL of the page that changed, the Host header with the current site, the other headers received, and the full or partial HTML.

Asynchronous Mode (For Production). SM will send an HTTP POST request with the target URL, headers, and partial or full HTML. The DS will schedule the analysis of the page, and immediately return 200 OK status code and no content.

Synchronous Mode (For Debugging). SM will send an HTTP POST request with the target URL, headers, and partial or full HTML. The DS will analyze the page right away, and return 200 OK status code with the fixes to the page.

Quick Synchronous Mode (For Production). SM will send an HTTP POST request with the target URL, headers, and partial or full HTML. The DS will analyze the page right away, and return 200 OK status code with a list of fixes the SM needs to apply to the page.

In later phases, the inventors will explore using a message queue, to communicate the SM and DS.

Extra Headers. SM will send an HTTP POST request with the target URL, headers, and partial or full HTML. The DS will analyze the page right away, and return 200 OK status codes with the fixes to the page.

Daemon Service to Real-time Dashboard. We configured a status dashboard using an open source package configured as follows:

Services. The specific SEO services/elements the present invention tracks are be configured manually. Canonicals this lists the current status of all known canonical tags of the site. Redirects this lists the current status of all known redirects of the site. Robots Tags lists the current status of all known robots tags of the site. Pagination Tags this lists the current status of all known pagination tags of the site. Hreflang Tags this lists the current status of all known hreflang tags of the site. Alternate Tags this lists the current status of all known mobile alternate tags of the site. Vary Header this lists the current status of the vary header. Errors this lists the most critical errors encountered by the search bots

Status Levels are a read-only configuration that lists all possible status levels. Broken one or more problems have been found with the specific service. Temporarily Fixed the system has placed a temporary solution to the problem detected with the specific service. Permanently Fixed the previously detected problem has been corrected with the specific service. Normally there are no problems with the specific service with the specific service and last temporary fix was recalled expiration_period_days ago.

The DS POSTs new statuses to the status dashboard to report new issues or new fixes to the corresponding service, and with the correct status level.

To allow manipulation of data map files managed by DS, simple REST-like API is provided.

Request url structure is as follows:

/api/1.0/(map type 1)/(map type 2)/(seo state)/(domain)

Where map type 1 is either static or dynamic, for static hash maps or regexes in binary tree files correspondingly, map type 2 is one of correct, temporary, recovery, unknown, seo state is one of canonical_url, robots, pagination, pagination_limits, hreflangs, and media. Domain is one of domains DS is configured to support.

Four methods are supported: GET, to fetch some or all key/value pairs, PUT, to populate hash/file tree with key/value pairs, POST, to update hash/file tree with key/value pairs, DELETE, to delete all or selected pairs.

The key is a static URL, and the value is one or two pagination tags separated by commas. Each pagination tag will have a label to indicate its type: prev or next. Urls are expected to have reserved characters escaped as per RFC 3986, meaning for example comma and colon will become %2C and %3A correspondingly.

The DBM file will have a key with the lookup URL from the HTTP request, and a value with the correct hreflang tags.

The key is a static URL, and the value is one or more hreflang tags separated by commas (in practice should be more two or more). Each hreflang tag will have a lower case label to indicate its language or language and region or default value x-default. Urls are expected to have reserved characters escaped as per RFC 3986, meaning for example comma and colon will become %2C and %3A correspondingly.

The DBM file will have a key with the lookup URL from the HTTP request, and a value with the correct mobile alternate tags. The key, and URL parts will be escaped to allow for reliable and fast parsing.

The key is a static URL, and the value is one or more alternate tags separated by commas. Each alternate tag will have a label in lower case to indicate the target device width. This is used to populate the media attribute of the tag. Urls are expected to have commas and colons in url path part quoted as per RFC 3986, meaning %2C and %3A correspondingly.

The DBM file will have a key with the name User-Agent-Needed from the HTTP request, and a value with True or False.

These maps will support, static URL mappings, Regex replacement (like mod rewrite), and XSLT/Xpath transformations for content.

As multiple rules could match the same URL, a priority will be needed. Matching will be performed in priority order, with no processing after first match. Static map match happens before rule match; in case of static match no rule match will be attempted. But, if there is no static URL map, the present invention will try all rule matches.

We have two types of maps for each type of SEO issue: a hash map for simple static URL mappings, and a file tree map to hold the dynamic rules. The insertion order will specify the priority implicitly.

The DS only reports errors to the dashboard for URLs found in the regex DBMs, and ignore everything else. The Regex URL DBM file will have a key with the lookup URL from the HTTP request, and a single value True. It will be used exclusively to match URLs to report to the dashboard. The Static URL DBM will be use to log the last error for a known URL.

Temporary Fixes always take priority over configuration settings. If there are temporary fixes for the requested URL, the fix needs to be applied and the correct status code returned to the client. But, the DS should always receive the original HTML without the fixes to avoid loops.

For example, if DSMode is Async, and there is a temporary fix, the updated HTML needs to be returned to the client instead of the unchanged one. Another example is if OnChanges is Retry-After, and there is a temporary fix, the client should not receive a 503 status code, but the correct status code and the fix. If the present invention doesn't do this, the bot will never get to see the fix until the configuration setting is changed back to NoWaiting.

Physical Canonical Removed (PCR): A User manually edits a page from the site and removes a canonical tag found in the dbm mapping file. When A user requests the page, the canonical needs to be put back, a message about the problem and fix is sent to real-time dashboard.

Physical Canonical Changed (PCC): A User manually edits a page from the site and change a canonical tag found in the dbm mapping file. When A User requests the page, the canonical needs to be replaced for the correct one, a message about the problem and fix is sent to real-time dashboard.

No Change (NC): A User requests the page with a correct canonical as found on the dbm nothing happens.

Physical Canonical Added Back (PCAB): A User manually edits a page from the site and restores a canonical tag found in the dbm mapping file. When a user requests the page, the module needs to stop inserting/replacing the canonical, a message about the permanent fix is sent to the real-time dashboard

Physical Redirect Removed (PRR): A user manually edits the .htaccess file of the site and remove a 301 redirect found in the dbm mapping file. When a user requests the page, the 301 redirect needs to be put back, a message about the problem and fix is sent to real-time dashboard.

Physical Redirect Changed (PRC): A user manually edits the .htaccess file of the site and change a 301 redirect found in the dbm mapping file to a 302. When a user requests the page, the 302 redirect needs to be replaced for a 301, a message about the problem and fix is sent to real-time dashboard. A user manually edits the .htaccess file of the site and change a 301 redirect found in the dbm mapping file to point to a different url. When a user requests the page, the 301 redirect needs to point to the correct page, a message about the problem and fix is sent to real-time dashboard.

No Change (NC): A user requests the page with a correct 301 redirect as found on the dbm and nothing happens.

Physical Redirect Added Back (PRAB): A user manually edits the .htaccess file of the site and restore a 301 redirect found in the dbm mapping file. When a user requests the page, the module needs to stop inserting/replacing the 301 redirect, a message about the permanent fix is sent to the real-time dashboard

Physical Noindex Removed (PNR): A user manually edits a page from the site and removes noindex from the robots tag for a page marked as True in the dbm mapping file. When a user requests the page, the noindex needs to be put back in the robots tag, a message about the problem and fix is sent to real-time dashboard.

No Change (NC): A user requests the page with a correct noindex in the robots tag for a page marked as True in the dbm and nothing happens.

Physical Noindex Added Back (PNAB): A user manually edits a page from the site and restores the noindex in the robots tag for a page marked as True in the dbm mapping file. When a user requests the page, the module needs to stop inserting/replacing the noindex, a message about the permanent fix is sent to the real-time dashboard

Physical Pagination Tag Removed (PPTR): A user manually edits a page from the site and removes a rel=prev or rel=next tag belonging to a URL found in the dbm mapping file. When a user requests the page, the removed pagination tag needs to be put back, a message about the problem and fix is sent to real-time dashboard.

Physical Pagination Tag Changed (PPTC): A user manually edits a page from the site and change a rel=prev or rel=next tag belonging to a URL found in the dbm mapping file. When a user requests the page, the changed pagination tag needs to be replaced for the correct one, a message about the problem and fix is sent to real-time dashboard.

No Change (NC): A user requests the page with correct pagination tags as found on the dbm nothing happens.

Physical Pagination Tag Added Back (PPTAB): A user manually edits a page from the site and restore a rel=prev or rel=next tag belonging to a URL found in the dbm mapping file. When a user requests the page, the module needs to stop inserting/replacing the pagination tag(s), a message about the permanent fix is sent to the real-time dashboard. The issue should not be considered resolved until all tags are implemented correctly.

New Paginated Page Added (NPPA): A user requests a new paginated page, and as result it is not available in the Correct SEO State maps. The DS needs to update the corresponding Pagination Range map in Correct SEO State maps, so the last page is this one.

Existing Paginated Page Removed (EPPR): A user requests a previously existing paginated page but get a 40× error. The Ds needs to update the corresponding Pagination Range map in the Correct SEO State maps, so it is not longer than the last page, but the corresponding previous page.

Physical Hreflang Tag Removed (PHTR): A user manually edits a page from the site and removes one or more hreflang tags belonging to a URL found in the dbm mapping file. When a user requests the page, the removed hreflang tag needs to be put back, a message about the problem and fix is sent to real-time dashboard.

Physical Hreflang Tag Changed (PHTC): A user manually edits a page from the site and changes one or more hreflang tags belonging to a URL found in the dbm mapping file. When A user requests the page, the changed hreflang tag needs to be replaced for the correct one, a message about the problem and fix is sent to real-time dashboard.

No Change (NC): A user requests the page with correct hreflang tags as found on the dbm nothing happens.

Physical Hreflang Tag Added Back (PHTAB): A user manually edits a page from the site and restores one or more hreflang tags tag belonging to a URL found in the dbm mapping file. When a user requests the page, the module needs to stop inserting/replacing the hreflang tag(s), a message about the permanent fix is sent to the real-time dashboard. The issue should not be considered resolved until all tags are implemented correctly.

Physical Alternate Tag Removed (PATR): A user manually edits a page from the site and removes one or more alternate tags belonging to a URL found in the dbm mapping file. When a user requests the page, the removed alternate tag needs to be put back, a message about the problem and fix is sent to real-time dashboard.

Physical Alternate Tag Changed (PATC): A user manually edits a page from the site and changes one or more alternate tags belonging to a URL found in the dbm mapping file. When a user requests the page, the changed alternate tag needs to be replaced for the correct one, a message about the problem and fix is sent to real-time dashboard.

No Change (NC): A user requests the page with correct alternate tags as found on the dbm nothing happens.

Physical Alternate Tag Added Back (PATAB): A user manually edits a page from the site and restores one or more alternate tags tag belonging to a URL found in the dbm mapping file. When a user requests the page, the module needs to stop inserting/replacing the alternate tag(s), a message about the permanent fix is sent to the real-time dashboard. The issue should not be considered resolved until all tags are implemented correctly.

Vary Header Removed (VHR): A user manually changes the web server settings and removes the Vary header. When a user requests any page, the Vary header needs to be put back, a message about the problem and fix is sent to real-time dashboard.

Vary Header Changed (VHC): A user manually changes the web server settings and change the Vary header to remove the User-Agent attribute, or to duplicate it. When a user requests any page, the Vary header needs to have a single User-Agent value again, a message about the problem and fix is sent to real-time dashboard.

No Change (NC): A user requests any page with and if the Vary header is present, and with the value User-Agent nothing happens.

Vary Header Added Back (VHAB): A user manually changes the web server settings and restores the Vary header to the correct setting. When a user requests any page, the module needs to stop inserting/replacing the Vary header, a message about the permanent fix is sent to the real-time dashboard

40×/50× Error Detected (4ED): A user manually edits the .htaccess file of the site and forces a 40×/50× status code for a URL found in the regex dbm mapping file. When a user requests the page, the 40×/50× error will reach the client/searchbot, but a message about the problem will be sent to the real-time dashboard.

40×/50× Error Corrected (4EC): A user manually edits the .htaccess file of the site and removes the 40×/50× status code for a URL found in the regex dbm mapping file that was placed previously. When a user requests the page, the 40×/50× error will disappear, but a message about the issue now corrected will be sent to the real-time dashboard.

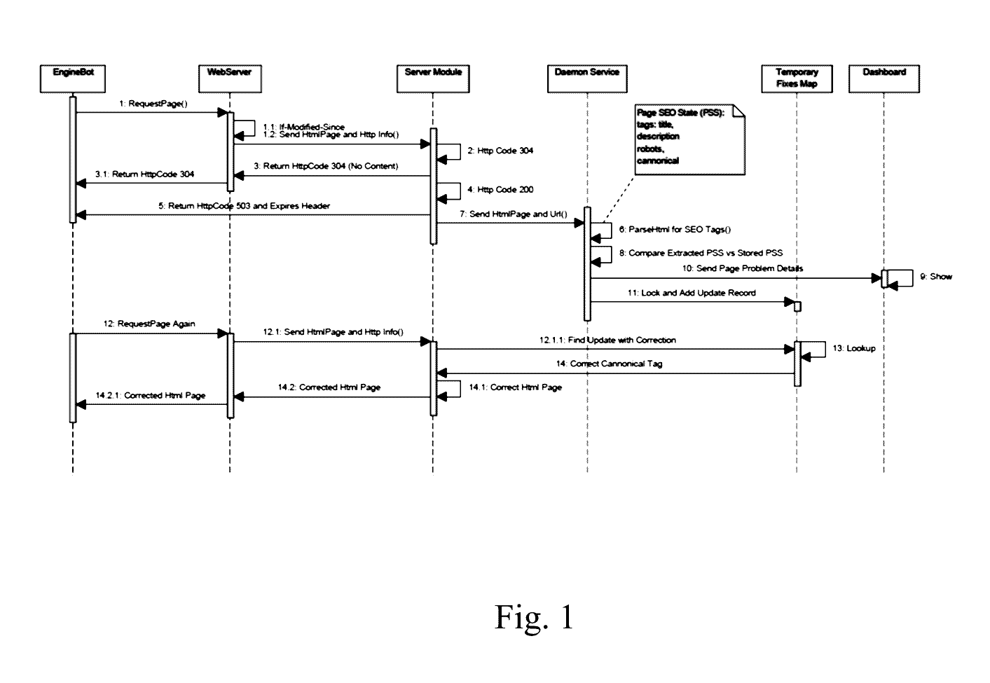

FIG. 1 illustrates the Asynchronous Processes With Change Detection by If-Modified-Since Solving the empty 304 body problem.

In the various steps below, the present invention may need to replace or add html elements (canonicals, meta tags etc.) when the present invention detects a 304 Not Modified on a file for which there is a temporary fix. However, the web server will NOT return a body with a 304 response, so how does the present invention parse non-existent html? The solution is to always remove the If-Modified-Since header from the incoming request, but store the time in the request context maintained by the filter for the request lifetime. With no If-Modified-Since client header, the web server will never send a 304 Not Modified. Thus, the present invention should always get a 200 OK with the html body. We will also get the Last-Modified response header from any web server which supports If-Modified-Since and 304 Not Modified. We will look at this Last-Modified response header, and

If last-modified is <=the stored if-modified-since, this is equivalent to a 304 case−the web server would have returned a 304 if the present invention had not removed the incoming If-Modified-Since header.

If there is no temporary fix, the present invention will replace the 200 status code with a 304, remove the body and any body related headers like Content-Length, Content-Encoding etc.; else if there is a temporary fix, the present invention will apply the fix.

Else (last-modified>the stored if-modified-since), this will be the normal 200 case and would be the same even if the present invention had not removed the incoming If-Modified-Since header.

The Canonical Update Processes where the Physical Canonical Removed (PCR), Physical Canonical Changed (PCC) Server Module (SM) following the following steps: 1. SM receives, from the webserver, the html source of the page when the visitor is a known search engine (like Googlebot); 2. SM checks status code is 200 (304 would mean there was no change); 3. SM sends page HTML, URL to DS; 4. Depending on configuration settings: 4.1 SM returns the untouched html, and 4.2 SM returns status code 503 (unavailable after) with a preconfigured expiration date/time. In this case, the search bot will not get the page this time, and will try again at a later time (as configured).

5. DS receives the html source of the page, and URL from SM. 6. DS parses html source to extract key SEO elements: title, meta description, robots, canonical, etc. We will call these Page SEO State (PSS). 7. DS compares the extracted PSS with the stored PSS in the Correct SEO State Maps for the URL, and the canonical tag will be found to be different. 8. DS notifies the real-time dashboard that a problem was detected, and provides relevant details. 9. DS locks the Temporary Fixes Map, and adds a new update record. 10. In this case, the URL received from the SM, and the correct canonical tag extracted from the stored PSS will be inserted in the Temporary Fixes Map. 11. DS notifies the real-time dashboard that a temporary fix is in place.

12. SM receives the html source of the page, from the webserver, for the URL found in the Temporary Fixes Map, when the visitor is a known search engine (like Googlebot). 13. SM checks status code and gets 304, which means there was no change. 14. SM looks up the URL in the Temporary Fixes Map, and finds an update with the correct canonical tag. 15. SM parses HTML, and inserts canonical tag in the Virtual HTML Stream

Physical Canonical Added Back (PAB) with respect to the Server Module (SM)

1. SM receives the html source of the page, from the webserver, when the visitor is a known search engine (like Googlebot); 2. SM checks status code is 200 (304 would mean there was no change); 3. SM sends page HTML, URL (and optionally checksum) to DS; 4. Depending on configuration settings: 4.1 SM returns the untouched html, and 4.2 SM returns status code 503 (unavailable after) with a preconfigured expiration date/time. In this case, the search bot will not get the page this time, and will try again at a later time (as configured)

Step 5. DS receives the html source of the page, and URL from SM. 6. DS parses html source to extract key SEO elements: title, meta description, robots, canonical, etc. We will call these Page SEO State (PSS). 7. DS compares the extracted PSS with the stored PSS in the Correct SEO State Maps for the URL, and the canonical tag will be found to be correct. 8. DS notifies the real-time dashboard that a permanent fix was detected, and provides relevant details. 9. DS locks the Temporary Fixes Map, and removes the corresponding update record. 10. In this case, the URL received from the SM, and the correct canonical tag extracted from the stored PSS will be removed from the Temporary Fixes Map

For the No Change (NC) Server Module (SM), Step 13. SM receives the html source of the page, from the webserver, for the URL previously found in the Temporary Fixes Map, when the visitor is a known search engine (like Googlebot) 14. SM checks status code is 304, which means there was no change 14. SM looks up the URL in the Temporary Fixes Map, and doesn't find a match 15. SM returns 304 status code with no content

The Redirect Update Processes for the Physical Redirect Removed (PRR) for the Server Module (SM) starts with step 1. SM receives, from the web server, the html source of the page when the visitor is a known search engine (like Googlebot); 2. SM checks status code is 200 (304 would mean there was no change); 3. SM sends page HTML, URL to DS; 4. Depending on configuration settings: 4.1 SM returns the untouched html, and 4.2 SM returns status code 503 (unavailable after) with a preconfigured expiration date/time. In this case, the search bot will not get the page this time, and will try again at a later time (as configured)

In step 5. DS receives the html source of the page, and URL from SM; 6. DS reviews headers and parses html source to extract key SEO elements: title, meta description, robots, canonical, etc. We will call these Page SEO State (PSS); 7. DS compares the extracted PSS with the stored PSS in the Correct SEO State Maps for the URL, and the page will be found to have the redirect removed; 8. DS notifies the real-time dashboard that a problem was detected, and provides relevant details; 9. DS locks the Temporary Fixes Map, and adds a new update record. 10. In this case, the URL received from the SM, and the correct redirect extracted from the stored PSS will be inserted in the Temporary Fixes Map. 11. DS notifies the real-time dashboard that a temporary fix is in place

In step 12. SM receives the html source of the page, from the webserver, for the URL found in the Temporary Fixes Map, when the visitor is a known search engine (like Googlebot) 13. SM checks status code and gets 304, which means there was no change 14. SM looks up the URL in the Temporary Fixes Map, and finds an update indicating it needs to correctly redirect. 15. SM updates the Virtual HTTP Headers to add the correct redirect

The Physical Redirect Added Back (PNAB) starts in step 1. SM receives the HTTP headers, and html source of the page, from the webserver, when the visitor is a known search engine (like Googlebot); 2. SM checks status code is 301/302/307 (304 would mean there was no change) 3. SM looks up the URL in the Temporary Fixes Map, and finds a match, but it is correct 4. SM sends page URL to DS with no HTML body to indicate the redirect has been fixed

In step 5. DS receives the http headers, and URL with no html source from SM 6. DS locks the Temporary Fixes Map, finds the URL and removes the corresponding update record 7. In this case, the URL received from the SM, and the correct redirect from the stored PSS will be removed from the Temporary Fixes Map 8. DS notifies the real-time dashboard that a permanent fix was detected, and provides relevant details

Physical Redirect Changed (PRC). In this special case, the SM will do the detection instead of the DS Server Module (SM). 1. SM receives, from the webserver, the http headers, and html source of the page when the visitor is a known search engine (like Googlebot) 2. SM checks status code is 301/302/307 (304 would mean there was no change) 3. SM looks up the URL in the Temporary Fixes Map, and finds no match, 4. SM compares the status code, and redirect URL to the ones found in the PSS, and will find that they don't match. We might have incorrect redirect status code or incorrect redirect URL 5. SM updates the Virtual HTTP Headers to add the correct redirect 6. SM sends page URL to DS with no HTML body to indicate the redirect problem

In step 7. DS receives the http headers, no html source of the page, and URL from SM 8. DS locks the Temporary Fixes Map, doesn't find the URL and adds the corresponding update record 9. In this case, the URL received from the SM, and the correct redirect from the stored PSS will be added to the Temporary Fixes Map 10. DS notifies the real-time dashboard that a permanent fix was detected, and provides relevant details

In step 11. SM receives the http headers, and html source of the page, from the webserver, for the URL found in the Temporary Fixes Map, when the visitor is a known search engine (like Googlebot) 12. SM checks status code is 301/302/307 (304 would mean there was no change) 13. SM looks up the URL in the Temporary Fixes Map, and finds an update indicating it needs to correctly redirect. 14. SM updates the Virtual HTTP Headers to add the correct redirect

In step 15. SM receives the HTTP headers, and html source of the page, from the webserver, for the URL previously found in the Temporary Fixes Map, when the visitor is a known search engine (like Googlebot) 16. SM checks status code is 304 which means there was no change 17. SM looks up the URL in the Temporary Fixes Map, and doesn't find a match 18. SM returns 304 status code with no content

Robots Tags Update Processes, Physical NoIndex Removed (PNR) starts when 1. SM receives, from the webserver, the html source of the page when the visitor is a known search engine (like Googlebot); 2. SM checks status code is 200 (304 would mean there was no change) 3. SM sends page HTML, URL to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the noindex attribute in the robots tag will be found to be different 8. DS notifies the real-time dashboard that a problem was detected, and provides relevant details 9. DS locks the Temporary Fixes Map, and adds a new update record 10. In this case, the URL received from the SM, and the correct robots tag extracted from the stored PSS will be inserted in the Temporary Fixes Map 11. DS notifies the real-time dashboard that a temporary fix is in place

In step 12. SM receives the html source of the page, from the webserver, for the URL found in the Temporary Fixes Map, when the visitor is a known search engine (like Googlebot) 13. SM checks status code and gets 304, which means there was no change 14. SM looks up the URL in the Temporary Fixes Map, and finds an update with the correct robots tag 15. SM parses HTML, and inserts robots tag with the noindex attribute in the Virtual HTML Stream

The Physical Noindex Added Back (PNAB) starts with 1. SM receives the html source of the page, from the webserver, when the visitor is a known search engine (like Googlebot) 2. SM checks status code is 200 (304 would mean there was no change) 3. SM sends page HTML, URL (and optionally checksum) to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the noindex in the robots tag will be found to be correct 8. DS notifies the real-time dashboard that a permanent fix was detected, and provides relevant details 9. DS locks the Temporary Fixes Map, and removes the corresponding update record 10. In this case, the URL received from the SM, and the correct robots tag extracted from the stored PSS will be removed from the Temporary Fixes Map

In step 13. SM receives the html source of the page, from the webserver, for the URL previously found in the Temporary Fixes Map, when the visitor is a known search engine (like Googlebot) 14. SM checks status code is 304, which means there was no change 14. SM looks up the URL in the Temporary Fixes Map, and doesn't find a match 15. SM returns 304 status code with no content

The Pagination Tags Update Processes, Physical Pagination Tag Removed (PPTR), Physical Pagination Tag Changed (PPTC) starts when 1. SM receives, from the webserver, the html source of the page when the visitor is a known search engine (like Googlebot) 2. SM checks status code is 200 (304 would mean there was no change) 3. SM sends page HTML, URL to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and a rel=prev or rel=next will be found to be missing 8. DS notifies the real-time dashboard that a problem was detected, and provides relevant details 9. DS locks the Temporary Fixes Map, and adds a new update record 10. In this case, the URL received from the SM, and the correct pagination tag(s) extracted from the stored PSS will be inserted in the Temporary Fixes Map 11. DS notifies the real-time dashboard that a temporary fix is in place

In step 12. SM receives the html source of the page, from the webserver, for the URL found in the Temporary Fixes Map, when the visitor is a known search engine (like Googlebot) 13. SM checks status code and gets 304, which means there was no change 14. SM looks up the URL in the Temporary Fixes Map, and finds an update with the correct pagination tag(s) 15. SM parses HTML, and inserts the pagination tags in the Virtual HTML Stream

The Physical Pagination Tag Added Back (PPTAB) starts with 1. SM receives the html source of the page, from the webserver, when the visitor is a known search engine (like Googlebot) 2. SM checks status code is 200 (304 would mean there was no change) 3. SM sends page HTML, URL (and optionally checksum) to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the pagination tag(s) will be found to be correct 8. DS notifies the real-time dashboard that a permanent fix was detected, and provides relevant details 9. DS locks the Temporary Fixes Map, and removes the corresponding update record 10. In this case, the URL received from the SM, and the correct pagination tag(s) extracted from the stored PSS will be removed from the Temporary Fixes Map

In step 13. SM receives the html source of the page, from the webserver, for the URL previously found in the Temporary Fixes Map, when the visitor is a known search engine (like Googlebot) 14. SM checks status code is 304, which means there was no change 14. SM looks up the URL in the Temporary Fixes Map, and doesn't find a match 15. SM returns 304 status code with no content

The Hreflang Tags Update Processes, Physical Hreflang Tag Removed (PHTR), Physical Hreflang Tag Changed (PHTC) starts with 1. SM receives, from the webserver, the html source of the page when the visitor is a known search engine (like Googlebot) 2. SM checks status code is 200 (304 would mean there was no change) 3. SM sends page HTML, URL to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and one or more hreflang tags will be found to be missing 8. DS notifies the real-time dashboard that a problem was detected, and provides relevant details 9. DS locks the Temporary Fixes Map, and adds a new update record 10. In this case, the URL received from the SM, and the correct hreflang tag(s) extracted from the stored PSS will be inserted in the Temporary Fixes Map 11. DS notifies the real-time dashboard that a temporary fix is in place

In step 12. SM receives the html source of the page, from the webserver, for the URL found in the Temporary Fixes Map, when the visitor is a known search engine (like Googlebot) 13. SM checks status code and gets 304, which means there was no change 14. SM looks up the URL in the Temporary Fixes Map, and finds an update with the correct hreflang tag(s) 15. SM parses HTML, and inserts the hreflang tags in the Virtual HTML Stream

The Physical Hreflang Tag Added Back (PHTAB) starts with 1. SM receives the html source of the page, from the webserver, when the visitor is a known search engine (like Googlebot) 2. SM checks status code is 200 (304 would mean there was no change) 3. SM sends page HTML, URL (and optionally checksum) to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the hreflang tag(s) will be found to be correct 8. DS notifies the real-time dashboard that a permanent fix was detected, and provides relevant details 9. DS locks the Temporary Fixes Map, and removes the corresponding update record 10. In this case, the URL received from the SM, and the correct hreflang tag(s) extracted from the stored PSS will be removed from the Temporary Fixes Map

In step 13. SM receives the html source of the page, from the webserver, for the URL previously found in the Temporary Fixes Map, when the visitor is a known search engine (like Googlebot) 14. SM checks status code is 304, which means there was no change 14. SM looks up the URL in the Temporary Fixes Map, and doesn't find a match 15. SM returns 304 status code with no content

The Alternate Tags Update Processes, Physical Alternate Tag Removed (PATR), Physical Alternate Tag Changed (PATC) starts with 1. SM receives, from the webserver, the html source of the page when the visitor is a known search engine (like Googlebot) 2. SM checks status code is 200 (304 would mean there was no change) 3. SM sends page HTML, URL to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and one or more alternate tags will be found to be missing 8. DS notifies the real-time dashboard that a problem was detected, and provides relevant details 9. DS locks the Temporary Fixes Map, and adds a new update record 10. In this case, the URL received from the SM, and the correct alternate tag(s) extracted from the stored PSS will be inserted in the Temporary Fixes Map 11. DS notifies the real-time dashboard that a temporary fix is in place

In step 12. SM receives the html source of the page, from the webserver, for the URL found in the Temporary Fixes Map, when the visitor is a known search engine (like Googlebot) 13. SM checks status code and gets 304, which means there was no change 14. SM looks up the URL in the Temporary Fixes Map, and finds an update with the correct alternate tag(s) 15. SM parses HTML, and inserts the hreflang tags in the Virtual HTML Stream

The Physical Alternate Tag Added Back (PATAB) starts with 1. SM receives the html source of the page, from the webserver, when the visitor is a known search engine (like Googlebot) 2. SM checks status code is 200 (304 would mean there was no change) 3. SM sends page HTML, URL (and optionally checksum) to DS 4. Depending on configuration settings: 4.1 SM returns the untouched html 4.2 SM returns status code 503 (unavailable after) with a preconfigured expiration date/time. In this case, the search bot will not get the page this time, and will try again at a later time (as configured)

In step 5. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the alternate tag(s) will be found to be correct 8. DS notifies the real-time dashboard that a permanent fix was detected, and provides relevant details 9. DS locks the Temporary Fixes Map, and removes the corresponding update record 10. In this case, the URL received from the SM, and the correct alternate tag(s) extracted from the stored PSS will be removed from the Temporary Fixes Map

In step 13. SM receives the html source of the page, from the webserver, for the URL previously found in the Temporary Fixes Map, when the visitor is a known search engine (like Googlebot) 14. SM checks status code is 304, which means there was no change 14. SM looks up the URL in the Temporary Fixes Map, and doesn't find a match 15. SM returns 304 status code with no content

Vary header update processes take regardless of URL requested, or whether there are changes to the body of the pages. The inspection and correction takes place on the SM, not in the DS like other SEO issues. The temporary SEO state will be cached in memory during web server start/restart. The DS will be notified just once per Vary header change. The updates to the Vary header Temporary Fixes Map will be done manually.

Physical Vary Header Removed (PVHR) starts with 1. SM receives, from the webserver, the headers of the page when the visitor is a known search engine (like Googlebot) 2. SM checks the correct SEO state for the Vary header and will find that the User-Agent value needs to be present, but the Vary header is missing. 3. SM adds the Vary header back to the client response, and includes the value “User-Agent”. 4. SM sends page HTML (if available), URL to DS, and the extra header X-Vary-Header-Changed, with the before and after values separated by semicolon. In this case: “;User-Agent” 5. Depending on configuration settings and other SEO issues that triggered the request, the response to the client will follow the usual course.

In step 5. DS receives the html source of the page (if applicable), and URL from SM 6. DS reviews headers and parses html source to extract key SEO elements: title, meta description, robots, canonical, etc. We will call these Page SEO State (PSS) 7. DS compares the extracted PSS with the stored PSS in the Correct SEO State Maps for the URL, and the page will be found to have the Vary header removed (among potentially other issues) 8. DS notifies the real-time dashboard that one (Vary header issue) or more problems were detected, and provides relevant details 9. If there are other issues besides the Vary header, the DS locks the Temporary Fixes Map, and adds a new update record 10. In this case, the URL received from the SM, and the correct SEO issue extracted from the stored PSS will be inserted in the Temporary Fixes Map 11. DS notifies the real-time dashboard that a temporary fix is in place

The Physical Vary Header Added Back (PVHAB) starts with 1. SM receives, from the webserver, the headers of the page when the visitor is a known search engine (like Googlebot) 2. SM checks the correct SEO state for the Vary header and will find that the User-Agent value needs to be present, and the Vary header has been added back with the value “User-Agent”. 3. SM stops adding the Vary header to the client response 4. SM sends page HTML (if available), URL to DS, and the extra header X-Vary-Header-Changed, with the before and after values separated by semicolon. In this case: “User-Agent;” 5. Depending on configuration settings and other SEO issues that triggered the request, the response to the client will follow the usual course.

In step 5. DS receives the html source of the page (if applicable), and URL from SM 6. DS reviews headers and parses html source to extract key SEO elements: title, meta description, robots, canonical, etc. We will call these Page SEO State (PSS) 7. DS compares the extracted PSS with the stored PSS in the Correct SEO State Maps for the URL, and the page will be found to have the Vary header added back (among potentially other issues) 8. DS notifies the real-time dashboard that the Vary header issue has been resolved, and notifies any other problems detected, and provides relevant details 9. If there are other issues besides the Vary header, the DS locks the Temporary Fixes Map, and adds a new update record 10. In this case, the URL received from the SM, and the correct SEO issue extracted from the stored PSS will be inserted in the Temporary Fixes Map 11. DS notifies the real-time dashboard that a temporary fix is in place

The Physical Vary Header Changed (PVHC) starts with 1. SM receives, from the webserver, the headers of the page when the visitor is a known search engine (like Googlebot) 2. SM checks the correct SEO state for the Vary header and will find that the User-Agent value needs to be present, the Vary header is present, but it doesn't include the value “User-Agent”. 3. SM adds the “User-Agent” value to the Vary header in the client response 4. SM sends page HTML (if available), URL to DS, and the extra header X-Vary-Header-Changed, with the before and after values separated by semicolon. In this case: “Accept-Encoding;Accept-Encoding,User-Agent” 5. Depending on configuration settings and other SEO issues that triggered the request, the response to the client will follow the usual course.

In step 5. DS receives the html source of the page (if applicable), and URL from SM 6. DS reviews headers and parses html source to extract key SEO elements: title, meta description, robots, canonical, etc. We will call these Page SEO State (PSS) 7. DS compares the extracted PSS with the stored PSS in the Correct SEO State Maps for the URL, and the page will be found to have the Vary header changed (among potentially other issues) 8. DS notifies the real-time dashboard that one (Vary header issue) or more problems were detected, and provides relevant details 9. If there are other issues besides the Vary header, the DS locks the Temporary Fixes Map, and adds a new update record 10. In this case, the URL received from the SM, and the correct SEO issue extracted from the stored PSS will be inserted in the Temporary Fixes Map 11. DS notifies the real-time dashboard that a temporary fix is in place

If there is No Change (NC), 1. SM receives, from the webserver, the headers of the page when the visitor is a known search engine (like Googlebot) 2. SM checks the correct SEO state for the Vary header and will find that the User-Agent value needs to be present, the Vary header is present, and it includes the value “User-Agent”. 3. If there aren't other issues, the SM does nothing 4. Depending on configuration settings and other SEO issues that triggered the request, the response to the client will follow the usual course.

40×/50× Notification Processes and 40×/50× Error Detected (4ED) starts with 1. SM receives, from the webserver, the html source of the page when the visitor is a known search engine (like Googlebot) 2. SM checks status code is 40×/50×3. SM sends page URL and extra headers to DS 4. SM returns the 40×/50× error code to the client/searchbot

In step 5. DS receives the URL and extra headers from the SM 6. DS reviews headers and determines is a 40×/50× error 7. DS compares the URL with the regexs in the Correct SEO State Maps for the URL, and the page will be found to be a match 8. DS notifies the real-time dashboard that an error was detected, and provides relevant details 9. DS locks the Correct SEO State Map for static URLs, and adds a new update record 10. In this case, the URL received from the SM, the status code, and the current timestamp

40×/50× Error Corrected (4EC) starts with 1. SM receives the HTTP headers, and html source of the page, from the webserver, when the visitor is a known search engine (like Googlebot) 2. SM checks status code is 200/30× (304 would mean there was no change) 3. SM looks up the URL in the Temporary Fixes Map, and finds no match 4. SM sends page URL to DS with HTML body if available

In step 5. DS receives the http headers, URL and html source if available from SM 6. DS checks the Correct SEO State maps for static URLs, and finds the URL was previously an error and removes the corresponding update record 7. In this case, the URL received from the SM, and the error status code (and timestamp) will be removed from the Correct SEO State map for static URLs 8. DS notifies the real-time dashboard that a permanent fix was detected, and provides relevant details.

The Synchronous Processes With Change Detection by If-Modified-Since, Canonical Update Processes, Physical Canonical Removed (PCR), Physical Canonical Changed (PCC) starts with 1. SM receives, from the webserver, the html source of the page when the visitor is a known search engine (like Googlebot) 2. SM checks status code is 200 (304 would mean there was no change) 3. SM sends page HTML, URL to DS, and gets the fixed page HTML with the correct canonical tag 10. SM returns the fixed html back to the search bot

In step 4. DS receives the html source of the page, and URL from SM 5. DS parses html source to extract key SEO elements: title, meta description, robots, canonical, etc. We will call these Page SEO State (PSS) 6. DS compares the extracted PSS with the stored PSS in the Correct SEO State Maps for the URL, and the canonical tag will be found to be different 7. DS notifies the real-time dashboard that a problem was detected, and provides relevant details 8. DS updates the html received from SM, and inserts the correct canonical tag 9. DS returns the fixed html back to the SM 11. DS locks the Temporary Fixes Map, and adds a new update record 12. In this case, the URL received from the SM, and the correct canonical tag extracted from the stored PSS will be inserted in the Temporary Fixes Map 13. DS notifies the real-time dashboard that a temporary fix is in place

The Physical Canonical Added Back (PAB) starts with 1. SM receives the html source of the page, from the webserver, when the visitor is a known search engine (like Googlebot) 2. SM checks status code is 200 (304 would mean there was no change) 3. SM sends page HTML, URL to DS, and gets 304 no change from the DS 10. SM returns the unchanged html back to the search bot, or 304 status code

In step 4. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the canonical tag will be found to be correct 8. DS notifies the real-time dashboard that a permanent fix was detected, and provides relevant details 9. DS returns status code 304 no change to SM. 10. DS locks the Temporary Fixes Map, and removes the corresponding update record 11. In this case, the URL received from the SM, and the correct canonical tag extracted from the stored PSS will be removed from the Temporary Fixes Map

If there is No Change (NC), 13. SM receives the html source of the page, from the webserver, for the URL previously found in the Temporary Fixes Map, when the visitor is a known search engine (like Googlebot) 14. SM checks status code is 304, which means there was no change 15. SM looks up the URL in the Temporary Fixes Map, and doesn't find a match 16. SM returns 304 status code with no content

The Redirect Update Processes is the same process as described for asynchronous mode because there is not extra work performed by DS. DS main responsibility is to report the redirect issues and fixes to the real-time dashboard and update the temporary fixes database.

The Robots Tags Update Processes, Physical NoIndex Removed (PNR) starts with 1. SM receives, from the webserver, the html source of the page when the visitor is a known search engine (like Googlebot) 2. SM checks status code is 200 (304 would mean there was no change) 3. SM sends page HTML, URL to DS, and gets the fixed page HTML with the correct noindex in the robots tag 10. SM returns the fixed html back to the search bot

In step 4. DS receives the html source of the page, and URL from SM 5. DS parses html source to extract key SEO elements: title, meta description, robots, canonical, etc. We will call these Page SEO State (PSS) 6. DS compares the extracted PSS with the stored PSS in the Correct SEO State Maps for the URL, and the noindex in the robots tag will be found to be different 7. DS notifies the real-time dashboard that a problem was detected, and provides relevant details 8. DS updates the html received from SM, and inserts the noindex in the robots tag 9. DS returns the fixed html back to the SM 11. DS locks the Temporary Fixes Map, and adds a new update record 12. In this case, the URL received from the SM, and the correct robots tag extracted from the stored PSS will be inserted in the Temporary Fixes Map 13. DS notifies the real-time dashboard that a temporary fix is in place

The Physical NoIndex Added Back (PAB) starts with 1. SM receives the html source of the page, from the webserver, when the visitor is a known search engine (like Googlebot) 2. SM checks status code is 200 (304 would mean there was no change) 3. SM sends page HTML, URL to DS, and gets 304 no change from the DS 10. SM returns the unchanged html back to the search bot, or 304 status code

In step 4. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the noindex in robots tag will be found to be correct 8. DS notifies the real-time dashboard that a permanent fix was detected, and provides relevant details 9. DS returns status code 304 no change to SM. 10. DS locks the Temporary Fixes Map, and removes the corresponding update record 11. In this case, the URL received from the SM, and the correct robots tag extracted from the stored PSS will be removed from the Temporary Fixes Map

If there is No Change (NC) 13. SM receives the html source of the page, from the webserver, for the URL previously found in the Temporary Fixes Map, when the visitor is a known search engine (like Googlebot) 14. SM checks status code is 304, which means there was no change 15. SM looks up the URL in the Temporary Fixes Map, and doesn't find a match 16. SM returns 304 status code with no content

The Pagination Tags Update Processes, Physical Pagination Tag Removed (PPTR), Physical Canonical Changed (PPTC) starts with 1. SM receives, from the webserver, the html source of the page when the visitor is a known search engine (like Googlebot) 2. SM checks status code is 200 (304 would mean there was no change) 3. SM sends page HTML, URL to DS, and gets the fixed page HTML with the correct pagination tag(s) 10. SM returns the fixed html back to the search bot

In step 4. DS receives the html source of the page, and URL from SM 5. DS parses html source to extract key SEO elements: title, meta description, robots, canonical, etc. We will call these Page SEO State (PSS) 6. DS compares the extracted PSS with the stored PSS in the Correct SEO State Maps for the URL, and the pagination tag(s) will be found to be different 7. DS notifies the real-time dashboard that a problem was detected, and provides relevant details 8. DS updates the html received from SM, and inserts the correct pagination tag(s) 9. DS returns the fixed html back to the SM 11. DS locks the Temporary Fixes Map, and adds a new update record 12. In this case, the URL received from the SM, and the correct pagination tag(s) extracted from the stored PSS will be inserted in the Temporary Fixes Map 13. DS notifies the real-time dashboard that a temporary fix is in place

The Physical Pagination Tag Added Back (PPTAB) starts when 1. SM receives the html source of the page, from the webserver, when the visitor is a known search engine (like Googlebot) 2. SM checks status code is 200 (304 would mean there was no change) 3. SM sends page HTML, URL to DS, and gets 304 no change from the DS 10. SM returns the unchanged html back to the search bot, or 304 status code

In step 4. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the pagination tag(s) will be found to be correct 8. DS notifies the real-time dashboard that a permanent fix was detected, and provides relevant details 9. DS returns status code 304 no change to SM. 10. DS locks the Temporary Fixes Map, and removes the corresponding update record 11. In this case, the URL received from the SM, and the correct pagination tag(s) extracted from the stored PSS will be removed from the Temporary Fixes Map

If there is No Change (NC), 13. SM receives the html source of the page, from the webserver, for the URL previously found in the Temporary Fixes Map, when the visitor is a known search engine (like Googlebot) 14. SM checks status code is 304, which means there was no change 15. SM looks up the URL in the Temporary Fixes Map, and doesn't find a match 16. SM returns 304 status code with no content

The Hreflang Tags Update Processes, Physical Hreflang Tag Removed (PHTR), Physical Hreflang Changed (PHTC) start with 1. SM receives, from the webserver, the html source of the page when the visitor is a known search engine (like Googlebot) 2. SM checks status code is 200 (304 would mean there was no change) 3. SM sends page HTML, URL to DS, and gets the fixed page HTML with the correct hreflang tag(s) 10. SM returns the fixed html back to the search bot

In step 4. DS receives the html source of the page, and URL from SM, 5. DS parses html source to extract key SEO elements: title, meta description, robots, canonical, etc. We will call these Page SEO State (PSS) 6. DS compares the extracted PSS with the stored PSS in the Correct SEO State Maps for the URL, and the hreflang tag(s) will be found to be different 7. DS notifies the real-time dashboard that a problem was detected, and provides relevant details 8. DS updates the html received from SM, and inserts the correct hreflang tag(s) 9. DS returns the fixed html back to the SM 11. DS locks the Temporary Fixes Map, and adds a new update record 12. In this case, the URL received from the SM, and the correct hreflang tag(s) extracted from the stored PSS will be inserted in the Temporary Fixes Map 13. DS notifies the real-time dashboard that a temporary fix is in place

The Physical Hreflang Tag Added Back (PPTAB) starts with 1. SM receives the html source of the page, from the webserver, when the visitor is a known search engine (like Googlebot) 2. SM checks status code is 200 (304 would mean there was no change) 3. SM sends page HTML, URL to DS, and gets 304 no change from the DS 10. SM returns the unchanged html back to the search bot, or 304 status code

In step 4. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the hreflang tag(s) will be found to be correct 8. DS notifies the real-time dashboard that a permanent fix was detected, and provides relevant details 9. DS returns status code 304 no change to SM. 10. DS locks the Temporary Fixes Map, and removes the corresponding update record 11. In this case, the URL received from the SM, and the correct hreflang tag(s) extracted from the stored PSS will be removed from the Temporary Fixes Map

If there in No Change (NC) 13. SM receives the html source of the page, from the webserver, for the URL previously found in the Temporary Fixes Map, when the visitor is a known search engine (like Googlebot) 14. SM checks status code is 304, which means there was no change 15. SM looks up the URL in the Temporary Fixes Map, and doesn't find a match 16. SM returns 304 status code with no content

The Alternate Tags Update Processes, Physical Alternate Tag Removed (PATR), Physical Alternate Changed (PATC) starts when 1. SM receives, from the webserver, the html source of the page when the visitor is a known search engine (like Googlebot) 2. SM checks status code is 200 (304 would mean there was no change) 3. SM sends page HTML, URL to DS, and gets the fixed page HTML with the correct alternate tag(s) 10. SM returns the fixed html back to the search bot

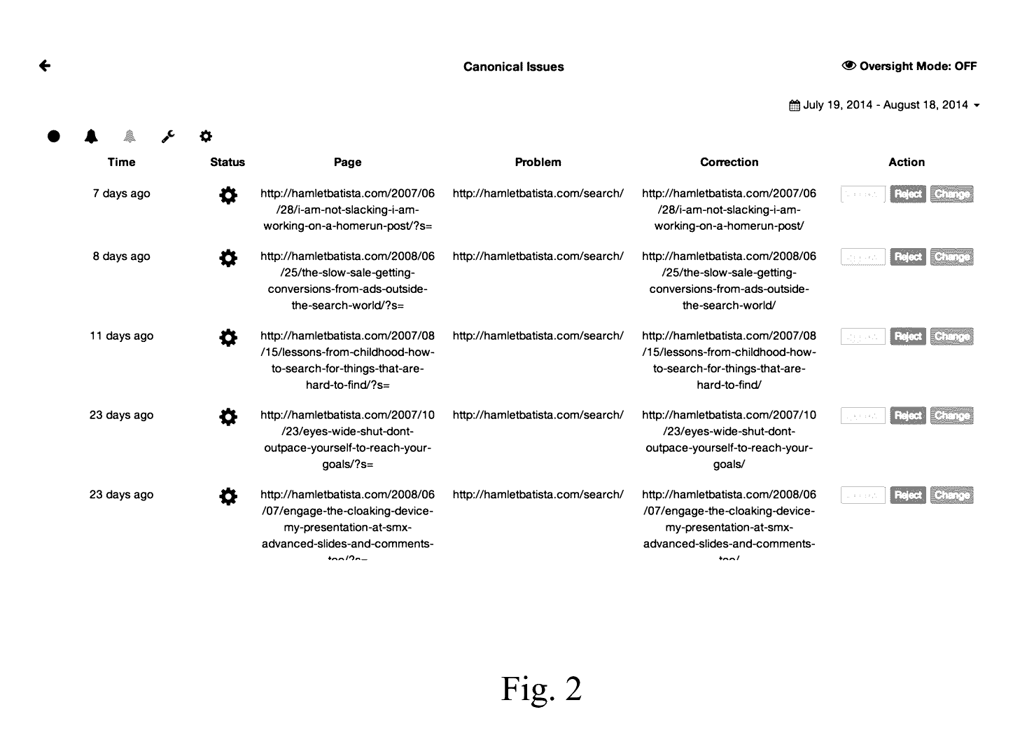

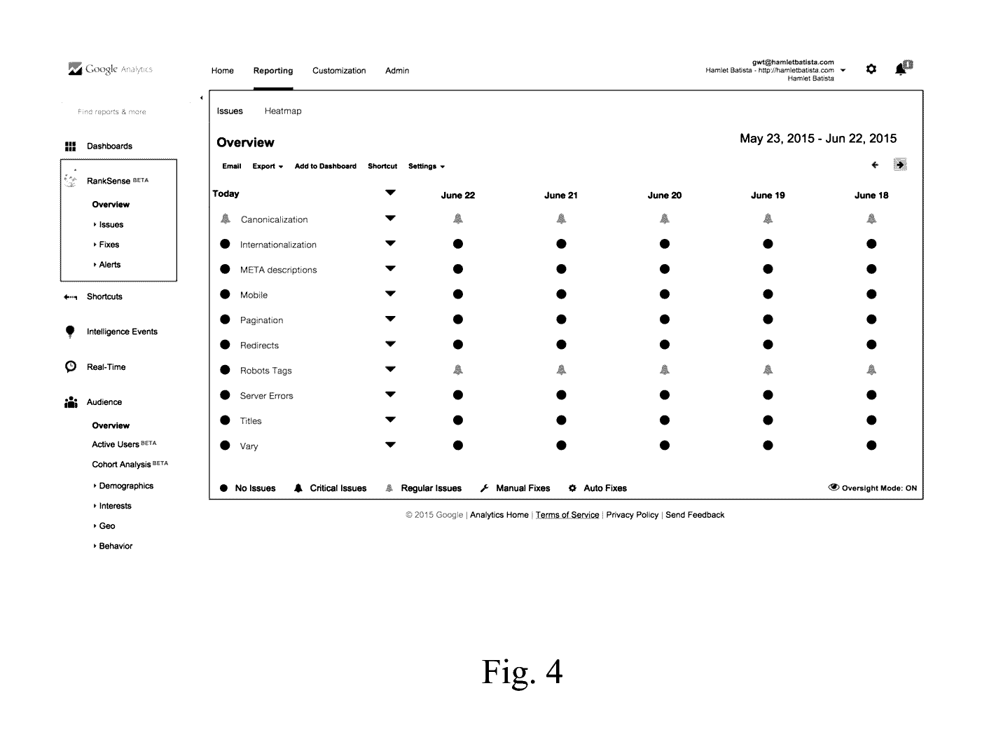

In step 4. DS receives the html source of the page, and URL from SM 5. DS parses html source to extract key SEO elements: title, meta description, robots, canonical, etc. We will call these Page SEO State (PSS) 6. DS compares the extracted PSS with the stored PSS in the Correct SEO State Maps for the URL, and the alternate tag(s) will be found to be different 7. DS notifies the real-time dashboard show in FIGS. 2-4 that a problem was detected, and provides relevant details 8. DS updates the html received from SM, and inserts the correct alternate tag(s) 9. DS returns the fixed html back to the SM 11. DS locks the Temporary Fixes Map, and adds a new update record 12. In this case, the URL received from the SM, and the correct alternate tag(s) extracted from the stored PSS will be inserted in the Temporary Fixes Map 13. DS notifies the real-time dashboard shown in FIGS. 2-4 that a temporary fix is in place.

The Physical Hreflang Tag Added Back (PPTAB) starts when 1. SM receives the html source of the page, from the webserver, when the visitor is a known search engine (like Googlebot) 2. SM checks status code is 200 (304 would mean there was no change) 3. SM sends page HTML, URL to DS, and gets 304 no change from the DS 10. SM returns the unchanged html back to the search bot, or 304 status code

In step 4. DS receives the html source of the page, and URL from SM 6. DS parses html source to extract key SEO elements: title, meta description, robots, canonical, etc. We will call these Page SEO State (PSS) 7. DS compares the extracted PSS with the stored PSS in the Correct SEO State Maps for the URL, and the alternate tag(s) will be found to be correct 8. DS notifies the real-time dashboard that a permanent fix was detected, and provides relevant details 9. DS returns status code 304 no change to SM. 10. DS locks the Temporary Fixes Map, and removes the corresponding update record 11. In this case, the URL received from the SM, and the correct alternate tag(s) extracted from the stored PSS will be removed from the Temporary Fixes Map

If there is No Change (NC), 13. SM receives the html source of the page, from the webserver, for the URL previously found in the Temporary Fixes Map, when the visitor is a known search engine (like Googlebot) 14. SM checks status code is 304, which means there was no change 15. SM looks up the URL in the Temporary Fixes Map, and doesn't find a match 16. SM returns 304 status code with no content

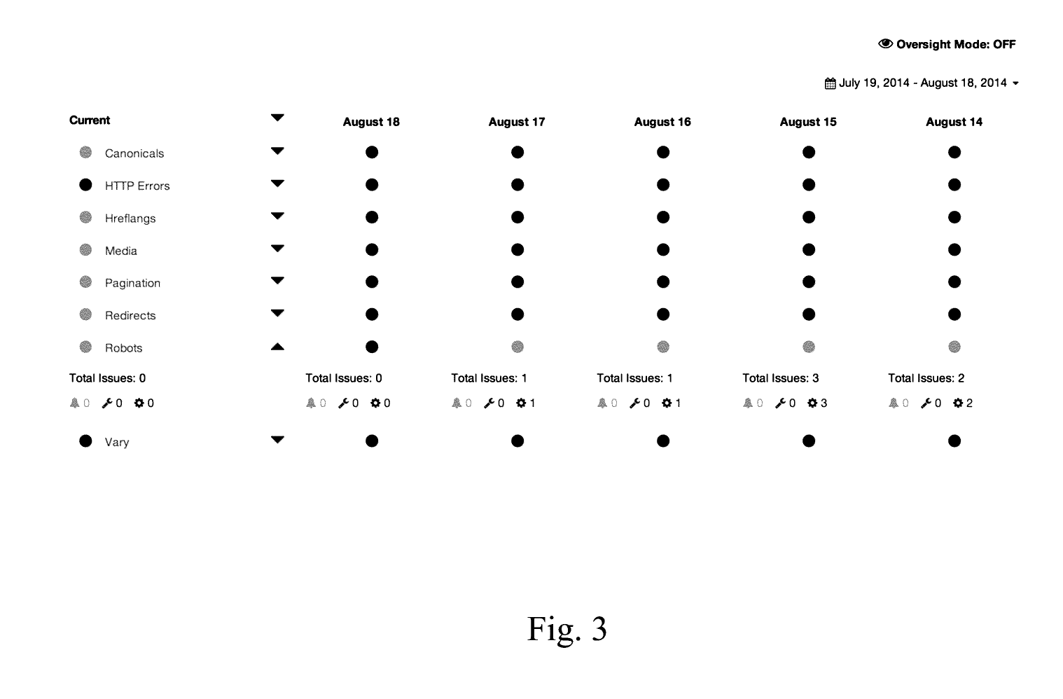

It is the same process as described for asynchronous mode because there is not extra work performed by DS. DS main responsibility is to report the Vary header issues and fixes to the real-time dashboard as shown in FIGS. 2-3.

The present invention teaches a portion of a dashboard that is directly embedded into a third party website analytics dashboard, (for example Google Analytics), by means of content injection using a web browser extension, (for example a Google Chrome extension). This provides a seamless experience to the user. Third party website analytics dashboards like GOOGLE Analytics are used by millions of website owners, the dashboard feels familiar as many users are trained on it. This makes it very easy for users to get started with the dashboard taught by the present invention.

The system and method relies on the following parts for the dashboard to work: 1. User's third party analytics account, i.e. GOOGLE Analytics account; 2. Web browser extension, i.e CHROME Extension; and 3. Our additional dashboard pages and data service.

The website must be configured first at the Dashboard server before it can be utilized. This is typically performed by the Dashboard Server Administrator. Once configured, the website has its dashboard related data in its container (called namespaces). The Dashboard Administrator must also assign at least one Administrator user for that website. This Administrator account is same as the GOOGLE Analytics Administrator account.

After creating the website's container and assigning administrative rights to one account, the website is not considered as “configured” for the Dashboard(s) taught by the present invention.

The present invention uses the GOOGLE accounts for authenticating the user against the Dashboard server. A user is already logged into their GOOGLE account when using Analytics. To get the user details on “who” the user is, the present invention will use GOOGLE Authentication (OAuth2) to be able to access their profile and email address.

If the user is a first time user for the Dashboard, a popup will be shown to them asking to initiate the authorization and grant permissions to the application to view their profile. After accepting these permissions for the first time, GOOGLE Accounts will keep track of the decision and the popup is not shown for subsequent authorization requests unless a user specifically revokes these permissions via GOOGLE Account Permissions. The application also receives an OAuth2 token for that particular user and request. For security of data and to prevent user-spoofing, the dashboard server uses this OAuth2 token and the GOOGLE Account email address to validate and authenticate the user.

When the GOOGLE Analytics Administrator installs the extension, and opens a configured website in GOOGLE Analytics, they will be required to configure a link the website from the GOOGLE Analytics Admin section. This linking is available only for websites already configured on the Dashboard server.

If the user not already authenticated with the Dashboard, the GOOGLE Analytics, the administrator is asked to authenticate when Linking the dashboard.

Linking enables one or more menu item in the reporting view and permissions for Dashboard in Admin view. It provides additional control to the Analytics Administrator on which websites they want the menu items shown.

The dashboard server exposes different web-API methods that can be invoked to fetch the data from the servers. Some of the functionality offered by these API methods is: Check if a website is supported and configured; Check if the user is authenticated and verify the user credentials; Get the data for different events and services; and Update data for approvals.

Most of the API methods require a valid user to make a request. The user authentication details must be passed in the HTTP headers for every request that is made to the servers.

Apart from the API methods, the dashboard server also hosts a set of pages for the application. These pages are used as embedded IFrame objects in: GOOGLE's Reporting view for the dashboard; and Initiating user-authentication for the application.

The dashboard is a single-page-application that uses the Dashboard APIs to make further requests for data.

The Extension injects additional scripts into GOOGLE Analytics views to enable additional functionality. It also embeds the Dashboard pages as iFrames when the user clicks the menu items. However these additional scripts from extension are a part of the domain “analytics.GOOGLE.com” and the Dashboard pages are a part of another external domain like “ . . . appspot.com” hosted on GOOGLE App Engine. This makes it complex to pass handling between e menu items and Dashboard pages.

For example “user clicked Canonicals to load the events in canonicals”. We cannot directly share the browser between two different domains data due to browser security restrictions.

To allow such communication browsers support message passing across frames in the browser. The present invention uses this to send data and events from extension to iframe (and vice-versa)

Once the CHROME Extension is installed, it injects the Dashboard pages and Setup pages into the GOOGLE Analytics view. The CHROME extension also helps interact with the dashboard's api-services.

The extension is configured to monitor load of Google Analytics domain in the browser. Once the extension detects Google Analytics opened, it will start the injection process.

When the user installs the extension, the extension check with the Dashboard API whether the website that is currently being analyzed is supported and it is configured at the Dashboard server. If it is configured, and the extension will initiate authentication to get the Google user's account. The menu item in Google Analytics is shown only if the website is linked by the administrator. If the user does not have permissions to the Dashboard, the present invention will show a message regarding the same.

Google Analytics provides no APIs for configurable user-interface. So the present invention has to come up with our own method that is reliable for long term. To inject menu items into Reporting view, the present invention will try to find the previous element using its unique ID class assigned by Google Analytics, for example: “ID-dashboard-menu-item”. Since these are reference IDs that will not change frequently, the present invention can rely on this to find the element. Similarly the present invention will use a few IDs to get an handle to the DOM elements generated by Google Analytics.

While it is possible that these IDs can change in future and structure can change in long term, the present invention keeps the dependency to the minimum and mostly depend on the structure available in the DOM structure.

Once the present invention has the menu item containers and an existing menu item DOM handle, the present invention fetches the HTML snippet underneath at runtime. This snippet is further parsed to fetch the style-classes used by Google. Once the present invention has the style classes the present invention creates another menu item using the information. We introduce some custom styles in the process, however it is minimal and only to the extent to achieve the required functionality.

When the user clicks on the Dashboard menu items, the present invention injects a structure in a similar manner—however the present invention loads the actual dashboard pages as an iFrame. This helps us keep the injected UI to the minimum. The dashboard pages are styled to match with the Google Analytics view such that the user viewing experience is seamless. Some of the elements like footers are injected right into the DOM for improved user-experience while scrolling through events.

When an admin-user accesses the Admin screens, the extension will also inject items like Linking item and in the User administration page it will inject additional permissions for Approve/Change/Reject/View. These additional permission settings are stored on the dashboard server.

For injected items, the extension calls the API methods on the dashboard server to read or update data

The present invention does not have any UI APIs from Google to fetch the current date filters used in the Google Analytics view. To do so the extension parses the URL to find out if a date filter is used and what are the filter-dates. It then uses message-passing to update the dates on the dashboard pages.

The server end also provides real time messaging by the means of App Engine Channel API. The client tool registers with the server for real time messages. Whenever an event is created, a real time message is sent to the registered clients. With the real time messaging available, the SEO Now Dashboard data is updated without the user having to refresh the page.

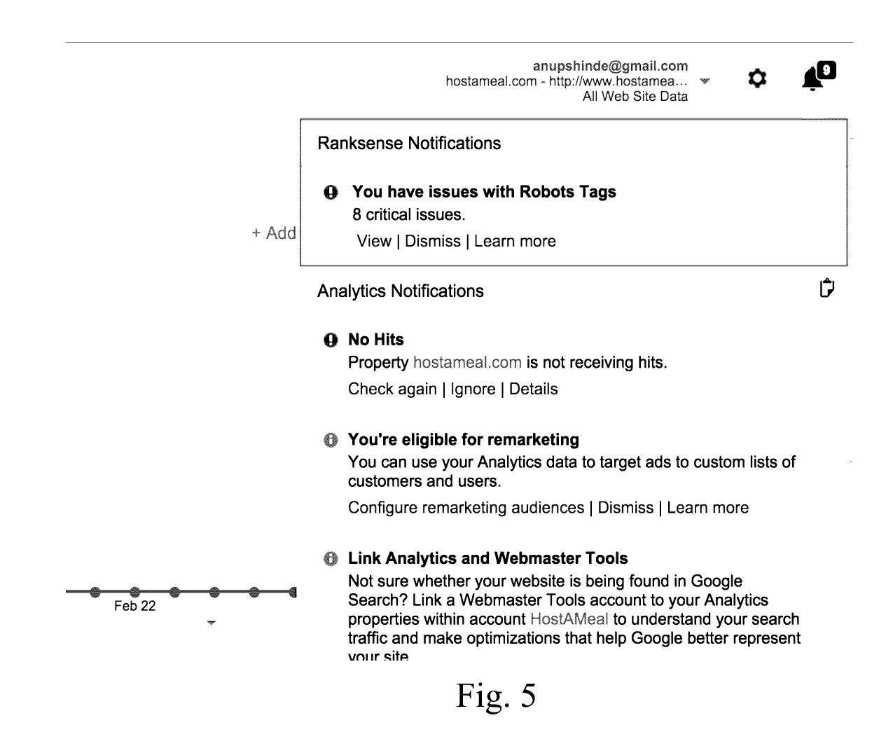

As shown in FIG. 5, the extension integrates Notifications on top of the Analytics notifications. The critical issues are summarized as a part of the notifications. The alert count for Google Analytics alerts is also incremented with the total number of critical events that have not been already dismissed.

The extension also allows the user to receive CHROME notifications for the critical events even when the Dashboard is not loaded. This is performed via the channel real time notifications received by the extension. These notifications are disabled by default and the user has the ability to enable/disable these notifications as needed.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for search engine optimization executable and rendered on the display of a machine, the method comprising:
providing on and executing by a computer;
a Server Module (SM) and
a Daemon Service (DS)
wherein the DS contains the SEO rules;
running a calibration step per website to establish the SEO rules; and
generating and displaying a dashboard presentation highlighting current and past SEO issues and fixes as green, yellow and red states.

2. The method of claim 1, wherein
the dashboard is directly embedded into an Analytics provider and provides a seamless experience to the user.

3. The method of claim 1, wherein
the system and method relies on the following parts for the dashboard to work:
a User's Analytics account;
a website Extension; and
one or more Dashboard pages and data service.

4. The method of claim 1, wherein
the website must be configured first at the Dashboard server before it can be utilized;
this is performed by the Dashboard Server Administrator;
once configured, the website has its dashboard related data in its container (called namespaces);
the Dashboard Administrator must also assign at least one Administrator user for that website; and
this Administrator account is same as the Analytics Administrator account.

5. The method of claim 1, wherein
the present invention uses the accounts for authenticating the user against the Dashboard server;
a user is already logged into their account when using Analytics; and
to get the user details on “who” the user is, using Authentication (OAuth2) to be able to access their profile and email address.

6. The method of claim 1, wherein
if the user is a first time user for the Dashboard, a popup will be shown to them asking to initiate the authorization and grant permissions to the application to view their profile;
after accepting these permissions for the first time, the Accounts will keep track of the decision and the popup is not shown for subsequent authorization requests unless a user specifically revokes these permissions via an Account Permissions;
the application also receives an OAuth2 token for that particular user and request; and
for security of data and to prevent user-spoofing, the dashboard server uses an OAuth2 token and the Account email address to validate and authenticate the user.

7. The method of claim 1, wherein
when the Analytics Administrator installs the extension, and opens a configured website in the Analytics, they will be required to configure a link the website from the Analytics Admin section.

8. The method of claim 1, wherein
if the user not already authenticated with the Dashboard, the Analytics, the administrator is asked to authenticate when Linking the dashboard; and
linking enables one or more menu item in the reporting view and permissions for Dashboard in Admin view.

9. The method of claim 1, wherein
the dashboard server exposes different web-API methods that can be invoked to fetch the data from the servers.

10. The method of claim 9, wherein the functionality offered by these API methods is:
checking if a website is supported and configured;
checking if the user is authenticated and verify the user credentials;
obtaining the data for different events and services; and
updating data for approvals.

11. The method of claim 1, wherein
the dashboard server also hosts a set of pages for the application;
these pages are used as embedded IFrame objects in,
a Reporting view for the dashboard, and
initiating user-authentication for the application.

12. The method of claim 1, wherein the dashboard is a single-page-application that uses the Dashboard APIs to make further requests for data.

13. The method of claim 1, wherein
the Extension injects additional scripts into the Analytics views to enable additional functionality; and
the extension embeds the Dashboard pages as iFrames when the user clicks the menu items.

14. The method of claim 13, wherein
the Dashboard pages are a part of another external domain hosted on an App Engine, making it complex to pass handling between the menu items and Dashboard pages; and
uses this to send data and events from extension to iframe (and vice-versa).

15. The method of claim 1, wherein
once the Extension is installed, it injects the Dashboard pages and Setup pages into the Analytics view; and
the extension also helps interact with the dashboard's API-services.

16. The method of claim 1, wherein
the extension is configured to monitor load of the Analytics domain in the browser; and
once the extension detects that the Analytics are opened, it will start the injection process.

17. The method of claim 1, wherein
when the user installs the extension, the extension check with the Dashboard API whether the website that is currently being analyzed is supported and it is configured at the Dashboard server;
if it is configured, and the extension will initiate authentication to get the user's account;
the menu items in Google Analytics are shown only if the website is linked by the administrator; and
if the user does not have permissions to the Dashboard, a message regarding the same is shown.

18. The method of claim 1, wherein once the present invention has the menu item containers,
an existing menu item DOM handle, fetches the HTML snippet underneath at runtime;
this snippet is further parsed to fetch the style-classes used by the software system;
once the present invention has the style classes; and
create another menu item using the information.

19. The method of claim 1, wherein
when the user clicks on the Dashboard menu items, the actual dashboard pages are loaded as an iFrame;
the dashboard pages are styled to match with the Google Analytics view such that the user viewing experience is seamless; and
footers are injected right into the DOM for improved user-experience while scrolling through events.

20. The method of claim 1, wherein
when an admin-user accesses the Admin screens, the extension will also inject items like Linking item and in the User administration page it will inject additional permissions for Approve/Change/Reject/View; and
these additional permission settings are stored on the dashboard server.

21. The method of claim 21, wherein
for injected items, the extension calls the API methods on the dashboard server to read or update data.

22. The method of claim 1, wherein
the extension parses the URL to find out if a date filter is used and what are the filter-dates. It then uses message-passing to update the dates on the dashboard pages.

23. The method of claim 1, wherein
the server end provides real time messaging by the means of App Engine Channel API;
the client tool registers with the server for real time messages;
whenever an event is created, a real time message is sent to the registered clients;
with the real time messaging available, the SEO Now Dashboard data is updated without the user having to refresh the page.

24. The method of claim 1, wherein
the extension integrates Notifications on top of the Analytics notifications;
the critical issues are summarized as a part of the notifications;
the alert count for Analytics alerts is also incremented with the total number of critical events that have not been already dismissed.

25. The method of claim 1, wherein
the extension also allows the user to receive web browser notifications for the critical events even when the Dashboard is not loaded;
this is performed via the channel real time notifications received by the extension.
